(19) United States
(12) Patent Application Publication
(10) Pub. No.: US 2023/0035268 A1
(43) Pub. Date: Feb. 2, 2023

(54) NANOEMULSIONS FOR USE IN SUBTERRANEAN FRACTURING TREATMENTS

(71) Applicant: Halliburton Energy Services, Inc., Houston, TX (US)

(72) Inventors: Liang Xu, The Woodlands, TX (US); Kai He, Houston, TX (US); Zhiwei Yue, Sugar Land, TX (US); Yang Peng, Kingwood, TX (US)

(73) Assignee: Halliburton Energy Services, Inc., Houston, TX (US)

(21) Appl. No.: 17/832,020

(22) Filed: Jun. 3, 2022

Related U.S. Application Data
(63) Continuation of application No. 16/341,968, filed on Apr. 15, 2019, now abandoned.

(51) Int. Cl. C09K 8/68; C09K 8/60; E21B 43/26

(52) U.S. Cl. CPC C09K 8/68; C09K 8/602; E21B 43/26; C09K 2208/26

(57) ABSTRACT

Methods for delivering treatment chemicals into a subterranean formation using treatment fluids that include nanoemulsions are provided. In some embodiments, the methods include providing a treatment fluid including an aqueous base fluid and a nanoemulsion including a water-soluble internal phase, a water-soluble external phase, and a surfactant, the nanoemulsion being formed by mechanically-induced shear rupturing; and introducing the treatment fluid into at least a portion of a subterranean formation at or above a pressure sufficient to create or enhance at least one fracture in the subterranean formation.

### CROSS-REFERENCE TO RELATED APPLICATION

The present application is a Continuation of U.S. patent application Ser. No. 16/341,968 filed Apr. 15, 2019, which is a U.S. National Stage Application of International Application No. PCT/US2016/063118 filed Nov. 21, 2016, which are incorporated herein by reference in their entirety for all purposes.

### BACKGROUND

The present disclosure relates to methods for treating subterranean formations.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like. For example, hydraulic fracturing is commonly used in stimulation of tight gas reservoirs using fracturing fluids, for example, crosslinked gelled fluids and/or slick water treatment fluids.

Chemical additives, including but not limited to scale inhibitors, friction reducers, biocides, clay swelling inhibitors, oxygen scavengers and surfactants, are often incorporated in a fracturing fluid in order to treat the newly-fractured areas of a formation. Among other reasons, these treatments may be used to facilitate the flow of hydrocarbons, clean up or prevent formation damage, and facilitate the flowback of the fracturing fluid. Viscosified fluids and emulsions have been used in the art to carry such treatment chemicals into various regions of a formation. However, certain regions of subterranean formations, particularly those where fracturing treatments are performed, may have low permeabilities, hindering the flow of viscosified treatment fluids, conventional emulsions, and chemicals into those regions. Moreover, the stability of a viscosified treatment fluid and/or conventional emulsion may be disrupted in the well, for example, when subjected to high shear forces.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a well treatment system that may be used in accordance with certain embodiments of the present disclosure.

FIG. 2 is a diagram illustrating an example of a subterranean formation in which a fracturing operation may be performed in accordance with certain embodiments of the present disclosure.

FIGS. 3A through 3F are graphs illustrating data relating to the droplet size distributions for certain microemulsions and nanoemulsions in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to systems and methods for treating subterranean formations. More particularly, the present disclosure relates to thermodynamically unstable nanoemulsions, and methods and systems relating to their use in the delivery of treatment chemicals downhole.

The present disclosure provides methods and systems for delivering treatment chemicals into a subterranean formation using treatment fluids that include nanoemulsions. As used herein, the term “nanoemulsion” refers to a dispersion of two immiscible liquids (e.g., an aqueous phase and an oil phase) in a kinetically stable but a thermodynamically unstable state (e.g., not the most thermodynamically stable state possible). This may be achieved at least in part where there is an energy barrier between the nanoemulsion state and the state where the two liquids are separated that is larger than the amount of free energy in the system. This is in contrast to microemulsions, which are formed when two immiscible liquids self-assemble in a dispersion to a thermodynamically stable state. In certain embodiments, the droplets of the internal phase in the external phase of the nanoemulsions of the present disclosure may have an average radius of less than about 1000 nm, or alternatively, less than about 500 nm, or alternatively, less than about 100 nm. These droplet sizes may be ascertained or measured by any known means, including but not limited to dynamic light scattering particle analysis techniques. In some embodiments, the nanoemulsions of the present disclosure may be formed by mechanically-induced shear rupturing of the two immiscible liquids, or by a phase inversion temperature method. The shear used in some embodiments to form certain nanoemulsions of the present disclosure may be applied at the surface and/or downhole in the formation by any known means, including but not limited to mechanical blenders. In some embodiments, the mechanical shear may be generated when the two immiscible liquids pass through a perforation in a casing or other equipment disposed in the subterranean formation. In certain embodiments, in contrast to microemulsions, the nanoemulsions of the present disclosure may remain substantially stable as emulsions when subjected to high mechanical shear, such as shear experienced by a fluid in a frac blender or when flowing through perforations in a casing.

The treatment fluids of the present disclosure generally include an aqueous base fluid and a nanoemulsion including a water-soluble external or continuous aqueous phase, a water-soluble internal or discontinuous oil phase, and a surfactant. The methods of the present disclosure generally include: providing a treatment fluid of the present disclosure; and introducing the treatment fluid into at least a portion of a subterranean formation. As used herein, the term “water soluble” or variations thereof refers to a substance having some degree of solubility in water, whether it is entirely soluble in water or only partially soluble in water.

The nanoemulsions of the present disclosure may, among other functions, aid in carrying a surfactant and/or other treatment chemicals into the porosity of a subterranean formation where it may be used to treat the formation. Such surfactants may, among other functions, alter the wettability of surfaces in the formation, facilitate the flow of certain fluids (e.g., hydrocarbons) out of the formation, reduce the flow of certain fluids (e.g., water) in the formation, and perform other desirable functions in a subterranean operation. In certain embodiments, the nanoemulsions of the present disclosure may be particularly helpful in delivering treatment chemicals and/or otherwise penetrating the formation matrix in unconventional formations, such as formations including shale having low porosity and/or permeability.

Among the many potential advantages to the methods and compositions of the present disclosure, only some of which are alluded to herein, the methods, compositions, and systems of the present disclosure may exhibit greater kinetic stability than certain other types of emulsions known in the art (e.g., microemulsions) under certain conditions such as high shear, elevated temperatures, and/or high pressures. This may allow the compositions of the present disclosure to be stored for a longer period of time, remain stable when subjected to such conditions during use, and/or other benefits or advantages. Moreover, in some embodiments, the nanoemulsions of the present disclosure may have narrower particle size distributions, more spherical droplet sizes, and/or more consistent properties when heated and/or cooled than other types of emulsions known in the art. In some embodiments, the nanoemulsions of the present disclosure also may be formed and/or stabilized using lower concentrations of surfactant than other nanoemulsions and/or microemulsions known in the art, which may reduce the cost associated with their preparation and/or use. In certain embodiments, the droplets of the nanoemulsions may break apart into even smaller droplets than those in the original nanoemulsion when subjected to high shear (e.g., a shear rate at or above 40 s⁻¹, or alternatively at or above 80 s⁻¹, or alternatively at or above 100 s⁻¹) without forming aggregates larger than the droplets of the original nanoemulsion. Among other purposes, these smaller droplets may be able to penetrate more deeply into the pore spaces of a subterranean formation (in particular, formations of low permeability) than the droplets of microemulsions and conventional emulsions known in the art. This may facilitate the delivery of the surfactant and/or other additives more deeply into the formation, particularly in low permeability formations.

The nanoemulsions of the present disclosure generally include two or more immiscible liquids, such as a polar (e.g., aqueous) fluid and a nonpolar (e.g., oil-based) fluid. Nanoemulsions of the present disclosure are generally thermodynamically unstable, but exhibit superior kinetic stability as compared to microemulsions and conventional emulsions known in the art, for example, when subjected to high shear or other conditions. In certain embodiments, the nanoemulsions of the present disclosure, once formed, may remain kinetically stable at ambient temperature and pressure for a period as short as 24 hours or as long as several months. In certain embodiments, the droplets of the discontinuous phase in the nanonemulsions of the present disclosure may have an average radius of about 100 nm or less, about 50 nm or less, about 10 nm or less, or about 5 nm or less. The two phases of the nanoemulsion may be included in any suitable amounts and/or ratios. For example, in certain embodiments, the nanoemulsion may include a polar phase and a nonpolar phase in a ratio of from about 99:1 to about 1:99. In certain embodiments, the polar phase and the nonpolar phase may be present in a ratio of from about 10:1 to about 1:1, for example. In certain embodiments, the polar phase and the nonpolar phase may be present in a ratio of about 4:1, for example.

In nanoemulsions including a polar phase, the polar phase may include, for example, any type of water and/or any aqueous liquid that is miscible in water. Examples of such liquids may include, but are not limited to fresh water (e.g., water that does not contain a significant amount of salts or other additives added thereto, aside from those found in generally available sources of water), salt water (e.g., water containing one or more salts dissolved therein), brine (e.g., saturated salt water), seawater, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, or any combination thereof. In certain embodiments, a substantial amount of alcohols, glycerins, glycols, and/or polyols may be absent from the nanoemulsions of the present disclosure. In nanoemulsions including an oil-based or oleaginous phase, the oil-based phase may include any type of oil-based liquid that has at least 1% solubility in water. Examples of such liquids may include, but are not limited to, oils, hydrocarbons, esters, ethers, non-polar organic liquids, and the like, for example. In certain embodiments, the oil-based or oleaginous phase may include one or more water-soluble solvents, including but not limited to alcohols and/or biodegradable solvents, for example.

The surfactants used in the nanoemulsions of the present disclosure may include any surfactant or combination thereof that is capable of emulsifying two immiscible fluids to form a nanoemulsion. These surfactants also may be used to treat a portion of a subterranean formation, for example, by altering the wettability of one or more surfaces downhole (as measured by any known method, including but not limited to contact angle measurements) and/or to facilitate the flow of certain types of fluids through the pore spaces in the formation. Depending upon the particular application, the surfactant may be cationic, anionic, nonionic, or amphoteric, may act as an emulsifier or demulsifier/breaker, and/or may be monomeric or polymeric. Types of cationic surfactants that may be suitable for certain embodiments of the present disclosure include, but are not limited to, arginine methyl esters, alkanolamines, alkylenediamines, alkyl amines, alkyl amine salts, quaternary ammonium salts such as trimethyltallowammonium chloride, amine oxides, alkyltrimethyl amines, triethyl amines, alkyldimethylbenzylamines, alkylamidobetaines such as cocoamidopropyl betaine, alpha-olefin sulfonate, C₈ to C₂₂ alkylethoxylate sulfate, trimethylcocoammonium chloride, derivatives thereof, and combinations thereof, for example. Types of anionic surfactants that may be suitable for certain embodiments of the present disclosure include, but are not limited to, alkali metal alkyl sulfates, alkyl ether sulfonates, alkyl sulfonates, alkylaryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, phosphate esters alkyl carboxylates, alkylether carboxylates, N-acylaminoacids, N-acylglutamates, N-acylpolypeptides, alkylbenzenesulfonates, paraffinic sulfonates, a-olefinsulfonates, lignosulfates, derivatives of sulfosuccinates, polynapthylmethylsulfonates, alkyl sulfates, alkylethersulfates, monoalkylphosphates, polyalkylphosphates, fatty acids, alkali salts of acids, alkali salts of fatty acids, alkaline salts of acids, sodium salts of acids, sodium salts of fatty acid, alkyl ethoxylate, soaps, derivatives thereof, and combinations thereof, for example. Types of non-ionic surfactants that may be suitable for certain embodiments of the present disclosure include, but are not limited to, amides, diamides, polyglycol esters, alkyl polyglycosides, sorbitan esters, methyl glucoside esters and alcohol ethoxylates alcohol oxylalkylates, alkyl phenol oxylalkylates, nonionic esters such as sorbitan esters alkoxylates of sorbitan esters, castor oil alkoxylates, fatty acid alkoxylates, lauryl alcohol alkoxylates, nonylphenol alkoxylates, octylphenol alkoxylates, tridecyl alcohol alkoxylates, combinations thereof, and derivatives thereof, for example. Examples of non-ionic surfactants that may be suitable include, but are not limited to, alkylphenol ethoxylates, nonylphenol ethoxylates, octylphenol ethoxylates, tridecyl alcohol ethoxylates, mannide monooleate, sorbitan isostearate, sorbitan laurate, sorbitan monoisostearate, sorbitan monolaurate, sorbitan monooleate, sorbitan monopalmitate, sorbitan monostearate, sorbitan oleate, sorbitan palmitate, sorbitan sesquioleate, sorbitan stearate, sorbitan trioleate, sorbitan tristearate, combinations thereof, derivatives thereof, and the like.

In certain embodiments, the surfactant may include an alkyl polyglycoside or derivative thereof (e.g., functionalized sulfonates, functionalized betaines, and/or inorganic salts of the alkyl polyglycoside) in a non-aromatic solvent such as an ethoxylated alcohol, an alkoxylated alcohol, a glycol ether, a disubstituted amide, a mixture of glycerine and acetone, isopropylidene glycerol, methanol, polyols, triethanolamine, ethylenediaminetetraacetic acid, N,N-dimethyl 9-decenamide, soya methyl ester, canola methyl ester, a mixture of methyl laurate and methyl myristate, a mixture of methyl soyate and ethyl lactate, alcohol alkoxy sulfates, sulfonates, any combination, and any derivative thereof. In certain embodiments, the surfactant may include an ethoxylated amine (e.g., ethoxylated tallow amine) or derivative thereof. Examples of specific blends of surfactants that may be suitable for use in certain embodiments of the present disclosure may include but are not limited to the following: blends of methyl-9-decenoate and alcohol alkoxyl sulfate; blends of C₁₅ olefins, ethoxylated alcohol, and alcohol alkoxyl sulfate; and blends of ethoxylated alcohol and ethoxylated amine, for example.

The surfactants of the present disclosure may be included in any amount suitable to produce a kinetically stable nanoemulsion. In certain embodiments, the surfactant (including any associated solvents) may be present an amount of less than about 500 parts per million (ppm). In certain embodiments, the surfactant may be present in an amount of from about 50 ppm to about 500 ppm. In certain embodiments, the surfactant may be present in an amount of from about 100 ppm to about 300 ppm. In certain embodiments, the surfactant may be present in an amount of about 100 ppm.

The nanoemulsions of the present disclosure also may include one or more co-surfactants. As used herein, a “co-surfactant” refers to a surfactant that participates in aggregation of molecules into a nanoemulsion but does not aggregate on its own. Co-surfactants that may be suitable for the nanoemulsions of the present disclosure include, but are not limited to, alcohols (e.g., propanol, butanol, pentanol in their different isomerization structures, ethoxylated and propoxylated alcohols), glycols, glycerols, polyols, phenols, thiols, isopropylidene, carboxylates, sulfonates, ketones, acrylamides, sulfonates, pyrrolidones, any derivative thereof, and any combination thereof.

The treatment fluids used in the methods and systems of the present disclosure may include any aqueous base fluid known in the art into which the nanoemulsion may be diluted. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may include water from any source. Examples of such aqueous fluids may include, but are not limited to, fresh water (e.g., water that does not contain a significant amount of salts or other additives added thereto, aside from those found in generally available sources of water), salt water (e.g., water containing one or more salts dissolved therein), brine (e.g., saturated salt water), seawater, or any combination thereof. In most embodiments of the present disclosure, the aqueous base fluid includes one or more ionic species, such as those formed by salts dissolved in water. For example, seawater and/or produced water may include a variety of divalent cationic species dissolved therein. In certain embodiments, the density of the aqueous base fluid can be adjusted, among other purposes, to provide additional particulate transport and suspension in the compositions of the present disclosure. In certain embodiments, the pH of the aqueous base fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate.

The nanoemulsions of the present disclosure may be included in a treatment fluid of the present disclosure in any suitable concentration. In certain embodiments, the nanoemulsion may be included in a treatment fluid in an amount of about 0.1 gallons per thousand gallons of the treatment fluid (gpt) to about 10 gpt by volume. In certain embodiments, the nanoemulsion may be included in a treatment fluid in an amount of about 0.5 gpt to about 5 gpt by volume. In certain embodiments, the nanoemulsion may be included in a treatment fluid in an amount of about 1 gpt to about 2 gpt by volume.

In certain embodiments, the treatment fluids used in the methods and systems of the present disclosure optionally may include any number of additional additives. The nanoemulsions of the present disclosure may, among other purposes, facilitate the delivery of surfactants and other optional treatment additives into certain regions (e.g., low permeability regions) of a formation. Examples of such additional additives include, but are not limited to, salts, additional surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, H₂S scavengers, CO₂ scavengers, oxygen scavengers, lubricants, viscosifiers, breakers, weighting agents, relative permeability modifiers, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The nanoemulsions and/or treatment fluids of the present disclosure may be prepared using any suitable method and/or equipment (e.g., blenders, mixers, stirrers, etc.) known in the art at any time prior to their use. The nanoemulsions and/or treatment fluids may be prepared at least in part at a well site or at an offsite location, and optionally may be stored for some period of time (e.g., at least a month) either at a well site or at an offsite location. In certain embodiments, the nanoemulsion and/or other components of the treatment fluid may be metered directly into a base fluid to form a treatment fluid. In certain embodiments, the base fluid may be mixed with the nanoemulsion and/or other components of the treatment fluid at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the nanoemulsions and/or treatment fluids of the present disclosure may be prepared, either in whole or in part, at an offsite location and transported to the site where the treatment or operation is conducted. In introducing a treatment fluid of the present disclosure into a portion of a subterranean formation, the components of the treatment fluid may be mixed together at the surface and introduced into the formation together, or one or more components may be introduced into the formation at the surface separately from other components such that the components mix or intermingle in a portion of the formation to form a treatment fluid. In either such case, the treatment fluid is deemed to be introduced into at least a portion of the subterranean formation for purposes of the present disclosure.

The present disclosure in some embodiments provides methods for using the treatment fluids to carry out a variety of subterranean treatments, including but not limited to, hydraulic fracturing treatments, acidizing treatments, and drilling operations. In some embodiments, the treatment fluids of the present disclosure may be used in treating a portion of a subterranean formation, for example, in acidizing treatments such as matrix acidizing or fracture acidizing. In certain embodiments, a treatment fluid may be introduced into a subterranean formation. In some embodiments, the treatment fluid may be introduced into a well bore that penetrates a subterranean formation. In some embodiments, the treatment fluid may be introduced at a pressure sufficient to create or enhance one or more fractures within the subterranean formation (e.g., hydraulic fracturing).

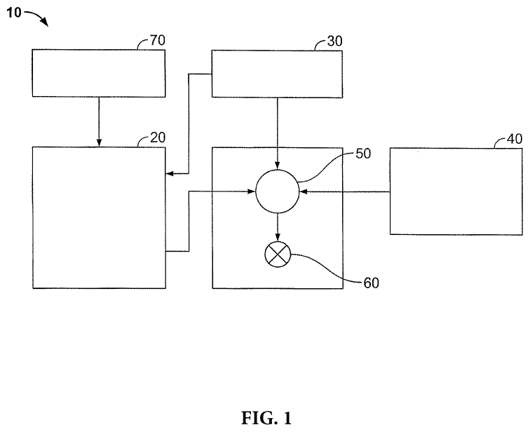

Certain embodiments of the methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a nanoemulsion with fluid (e.g., liquid or substantially liquid) from fluid source 30, to produce a fracturing fluid that may be used to fracture the formation. The fracturing fluid can be a fluid ready for use in a fracture stimulation treatment of the well 60 or a concentrate to which additional fluid is added prior to use in a fracture stimulation of the well 60. In some embodiments, the fracturing fluid producing apparatus 20 can be omitted and the fracturing fluid sourced directly from the fluid source 30. In certain embodiments, the fracturing fluid may include water, a hydrocarbon fluid, a polymer gel, foam, air, wet gases and/or other fluids.

The proppant source 40 can include a proppant for combination with the fracturing fluid. In certain embodiments, one or more treatment particulates of the present disclosure may be provided in the proppant source 40 and thereby combined with the fracturing fluid with the proppant. The system may also include additive source 70 that provides one or more additives (e.g., a nanoemulsion of the present disclosure, gelling agents, surfactants, weighting agents, and/or other additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppant particles, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppant particles at other times, and combinations of those components at yet other times.

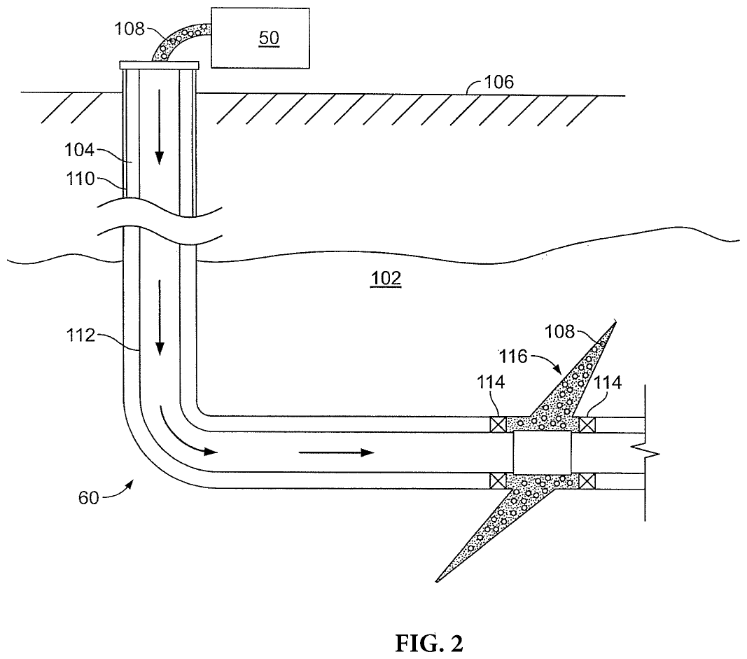

FIG. 2 shows the well 60 during a fracturing operation in a portion of a subterranean formation of interest 102 surrounding a wellbore 104. The wellbore 104 extends from the surface 106, and the fracturing fluid 108 is applied to a portion of the subterranean formation 102 surrounding the horizontal portion of the wellbore. Although shown as vertical deviating to horizontal, the wellbore 104 may include horizontal, vertical, slant, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the wellbore 104. The pump and blender system 50 is coupled a work string 112 to pump the fracturing fluid 108 into the wellbore 104. The working string 112 may include coiled tubing, jointed pipe, and/or other structures that allow fluid to flow into the wellbore 104. The working string 112 can include flow control devices, bypass valves, ports, and or other tools or well devices that control a flow of fluid from the interior of the working string 112 into the subterranean zone 102. For example, the working string 112 may include ports adjacent the wellbore wall to communicate the fracturing fluid 108 directly into the subterranean formation 102, and/or the working string 112 may include ports that are spaced apart from the wellbore wall to communicate the fracturing fluid 108 into an annulus in the wellbore between the working string 112 and the wellbore wall.

The working string 112 and/or the wellbore 104 may include one or more sets of packers 114 that seal the annulus between the working string 112 and wellbore 104 to define an interval of the wellbore 104 into which the fracturing fluid 108 will be pumped. FIG. 2 shows two packers 114, one defining an uphole boundary of the interval and one defining the downhole end of the interval. When the fracturing fluid 108 is introduced into wellbore 104 (e.g., in FIG. 2, the area of the wellbore 104 between packers 114) at a sufficient hydraulic pressure, one or more fractures 116 may be created in the subterranean zone 102. The proppant particulates (and/or treatment particulates of the present disclosure) in the fracturing fluid 108 may enter the fractures 116 where they may remain after the fracturing fluid flows out of the wellbore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

An embodiment of the present disclosure is a method including: providing a treatment fluid including an aqueous base fluid and a nanoemulsion including a water-soluble internal phase, a water-soluble external phase, and a surfactant; and introducing the treatment fluid into at least a portion of a subterranean formation at or above a pressure sufficient to create or enhance at least one fracture in the subterranean formation.

In one or more embodiments described in the preceding paragraph, the water-soluble internal phase includes an oil-based fluid and the external phase includes an aqueous fluid. In one or more embodiments described above, the water-soluble internal phase includes droplets having an average radius of about 100 nm or less as measured using a dynamic light scattering particle analysis technique. In one or more embodiments described above, the surfactant is present in the nanoemulsion in an amount of about 500 parts per million or less. In one or more embodiments described above, the surfactant includes at least one surfactant selected from a nonionic surfactant, an anionic surfactant, a cationic surfactant, an amphoteric surfactant, and any combination thereof. In one or more embodiments described above, the surfactant is a demulsifier or breaker. In one or more embodiments described above, the surfactant includes at least one surfactant selected from an alcohol alkoxy sulfate, an ethoxylated alcohol, and any combination thereof. In one or more embodiments described above, the surfactant includes one or more solvents. In one or more embodiments described above, the subterranean formation includes an unconventional formation. In one or more embodiments described above, the subterranean formation includes shale. In one or more embodiments described above, the nanoemulsion further includes at least one treatment additive selected from a salt, an acid, a diverting agent, a fluid loss control additive, a gas, a surface modifying agent, a tackifying agent, a foamer, a corrosion inhibitor, a scale inhibitor, a catalyst, a clay control agent, a biocide, a friction reducer, an antifoam agent, a bridging agent, a flocculant, an H₂S scavenger, a CO₂ scavenger, an oxygen scavenger, a lubricant, a viscosifier, a breaker, a weighting agent, a relative permeability modifier, a resin, a wetting agent, a coating enhancement agent, a filter cake removal agent, an antifreeze agent, and any combination thereof. In one or more embodiments described above, the treatment fluid is introduced into the subterranean formation using one or more pumps. In one or more embodiments described above, the nanoemulsion is formed by shearing at least two immiscible fluids in a blender.

Another embodiment of the present disclosure is a method including: providing a treatment fluid including an aqueous base fluid and a nanoemulsion including: a water-soluble internal non-polar phase, a water-soluble external polar phase, and a nonionic surfactant that includes an alcohol alkoxy sulfate, an ethoxylated alcohol, isopropylidene glycerol, one or more polyols, and water; and introducing the treatment fluid into at least a portion of a subterranean formation at or above a pressure sufficient to create or enhance at least one fracture in the subterranean formation.

In one or more embodiments described in the preceding paragraph, the subterranean formation includes an unconventional formation. In one or more embodiments described above, the water-soluble internal non-polar phase includes droplets having an average radius of about 100 nm or less as measured using a dynamic light scattering particle analysis technique. In one or more embodiments described above, the nonionic surfactant is present in the nanoemulsion in an amount of about 500 parts per million or less. In one or more embodiments described above, the surfactant is a demulsifier or breaker.

Another embodiment of the present disclosure is a method including: providing a treatment fluid including an aqueous base fluid and a nanoemulsion comprising a water-soluble internal phase, a water-soluble external phase, and a surfactant, wherein the water-soluble internal phase includes droplets having an average radius of about 100 nm or less as measured using a dynamic light scattering particle analysis technique; and introducing the treatment fluid into at least a portion of a subterranean formation at or above a pressure sufficient to create or enhance at least one fracture in the subterranean formation.

In one or more embodiments described in the preceding paragraph, the surfactant is present in the nanoemulsion in an amount of about 500 parts per million or less.

To facilitate a better understanding of the present disclosure, the following examples of certain aspects of certain embodiments are given. The following examples are not the only examples that could be given according to the present disclosure and are not intended to limit the scope of the disclosure or claims.

### EXAMPLES

### Example 1

The concentration for an example of a surfactant of the present disclosure (including a blend of ethoxylated alcohol, ethoxylated amine, isopropylidene glycerol, polyols, and water) was calculated by measuring the surface tension of an oil-in-water nanoemulsion at various concentrations. The results of those measurements are shown in Table 1 below.

TABLE 1

| Surfactant | Surface |
|---|---|
| concentration (ppm) | tension (mN/m) |
| 100 | 33.18 |
| 200 | 33.13 |
| 1000 | 33.23 |

As shown above, the surfactant provided adequate surface tension to stabilize a nanoemulsion at a concentration of about 100 ppm.

### Example 2

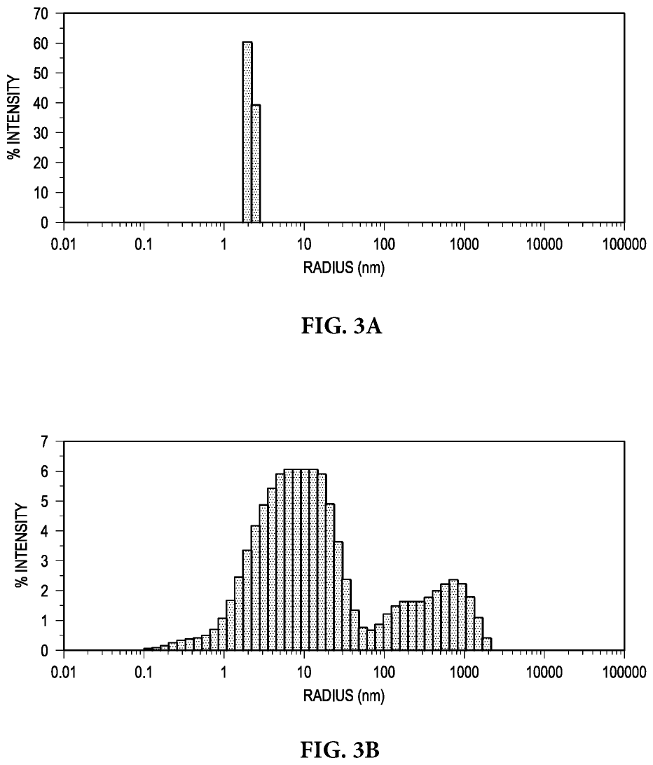

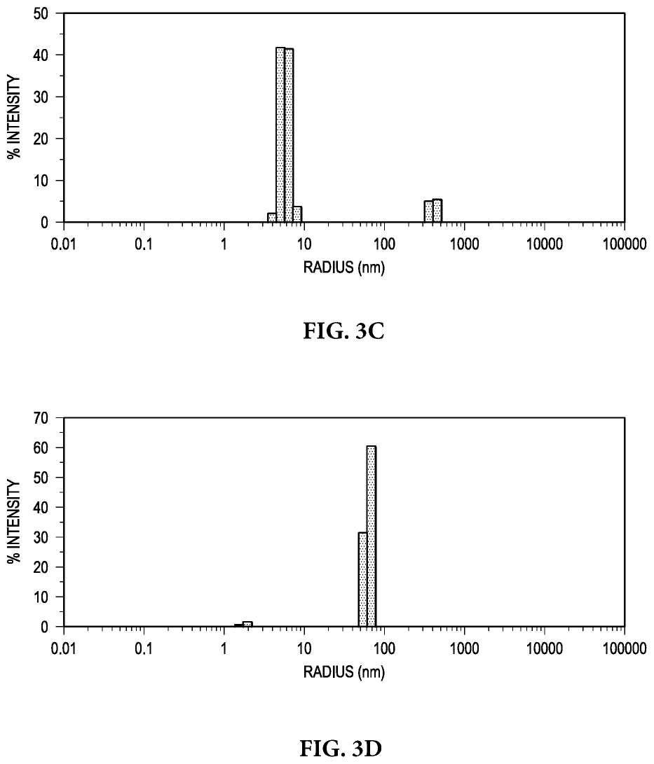

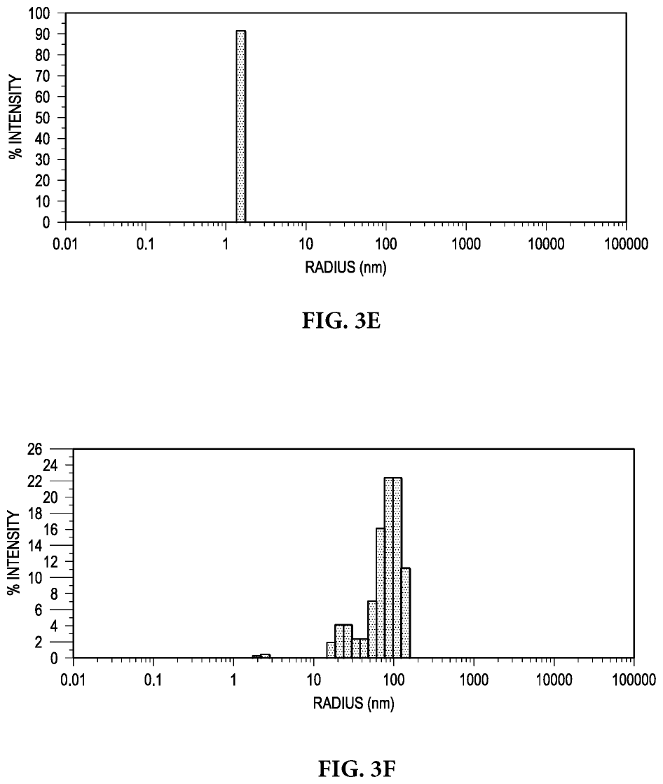

The nanoemulsion of Example 1 having a 100 ppm surfactant concentration was tested for its kinetic stability under high shear as compared to a conventional microemulsion product of the following composition (based on publicly available MSDS data): 5-10% citrus extract as oil phase, 5-10% ethoxylated amine, 1-5% branched ethoxylated alcohol, and 15-40% ethanol/isopropyl alcohol solvent. The size distributions of the droplets in the nanoemulsion and microemulsion were measured using a DelsaMax dynamic light scattering particle analyzer (scanning particle size from 0.4 nm to 10,000 nm), in both neat (100% concentration) samples and samples diluted to a concentration of 1 gallons per thousand gallons (gpt) in an aqueous 4% KCl solution. Then, the diluted samples were subjected to high shear (4000 rpm) in a high shearing blender for 30 minutes, and the size distributions of their droplets were measured after being sheared. The plots from the dynamic light scattering device showing the droplet size distributions of the various samples are shown in FIGS. 3A through 3F, and the droplet radius at the highest peaks in those distributions are shown in Table 2 below for each sample.

TABLE 2

Radius at highest peak (nm)

| | Nanoemulsion | Microemulsion |
|---|---|---|
| Neat | 2.2 (FIG. 3A) | 11.3 (FIG. 3B) |
| Diluted 1 gpt | 5.9 (FIG. 3C) | 65.3 (FIG. 3D) |
| Diluted 1 gpt after shear | 1.6 (FIG. 3E) | 95.3 (FIG. 3F) |

As shown above, the nanoemulsions of the present disclosure were able to maintain smaller droplet sizes, even after being subjected to high shear.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid comprising an aqueous base fluid and a nanoemulsion comprising a water-soluble internal phase, a water-soluble external phase, and a surfactant, wherein the nanoemulsion is formed by mechanically-induced shear rupturing; and
introducing the treatment fluid into at least a portion of a subterranean formation at or above a pressure sufficient to create or enhance at least one fracture in the subterranean formation.

2. The method of claim 1 wherein the water-soluble internal phase comprises an oil-based fluid and the external phase comprises an aqueous fluid.

3. The method of claim 1 wherein the water-soluble internal phase comprises droplets having an average radius of about 100 nm or less as measured using a dynamic light scattering particle analysis technique.

4. The method of claim 1 wherein the surfactant is present in the nanoemulsion in an amount of about 500 parts per million or less.

5. The method of claim 1 wherein the surfactant comprises at least one surfactant selected from a nonionic surfactant, an anionic surfactant, a cationic surfactant, an amphoteric surfactant, and any combination thereof.

6. The method of claim 1 wherein the surfactant is a demulsifier or breaker.

7. The method of claim 1 wherein the surfactant comprises at least one surfactant selected from an alcohol alkoxy sulfate, an ethoxylated alcohol, and any combination thereof.

8. The method of claim 1 wherein the surfactant comprises one or more solvents.

9. The method of claim 1 wherein the subterranean formation comprises an unconventional formation.

10. The method of claim 1 wherein the subterranean formation comprises shale.

11. The method of claim 1 wherein the nanoemulsion further comprises at least one treatment additive selected from a salt, an acid, a diverting agent, a fluid loss control additive, a gas, a surface modifying agent, a tackifying agent, a foamer, a corrosion inhibitor, a scale inhibitor, a catalyst, a clay control agent, a biocide, a friction reducer, an antifoam agent, a bridging agent, a flocculant, an H₂S scavenger, a CO₂ scavenger, an oxygen scavenger, a lubricant, a viscosifier, a breaker, a weighting agent, a relative permeability modifier, a resin, a wetting agent, a coating enhancement agent, a filter cake removal agent, an antifreeze agent, and any combination thereof.

12. The method of claim 1 wherein the treatment fluid is introduced into the subterranean formation using one or more pumps.

13. A method comprising:
providing a treatment fluid comprising an aqueous base fluid and a nanoemulsion formed by mechanically-induced shear rupturing comprising:
a water-soluble internal non-polar phase,
a water-soluble external polar phase, and
a nonionic surfactant that comprises an alcohol alkoxy sulfate, an ethoxylated alcohol,
isopropylidene glycerol, one or more polyols, and water; and
introducing the treatment fluid into at least a portion of a subterranean formation at or above a pressure sufficient to create or enhance at least one fracture in the subterranean formation.

14. The method of claim 13 wherein the subterranean formation comprises an unconventional formation.

15. The method of claim 13 wherein the water-soluble non-polar internal phase comprises droplets having an average radius of about 100 nm or less as measured using a dynamic light scattering particle analysis technique.

16. The method of claim 13 wherein the nonionic surfactant is present in the nanoemulsion in an amount of about 500 parts per million or less.

17. The method of claim 13 wherein the surfactant is a demulsifier or breaker.

18. A method comprising:
providing a treatment fluid comprising an aqueous base fluid and a nanoemulsion comprising a water-soluble internal phase, a water-soluble external phase, and a surfactant, wherein the water-soluble internal phase comprises droplets having an average radius of about 100 nm or less as measured using a dynamic light scattering particle analysis technique, wherein the nanoemulsion is formed by mechanically-induced shear rupturing; and
introducing the treatment fluid into at least a portion of a subterranean formation at or above a pressure sufficient to create or enhance at least one fracture in the subterranean formation.

19. The method of claim 18 wherein the surfactant is present in the nanoemulsion in an amount of about 500 parts per million or less.

20. The method of claim 18 wherein the surfactant is a demulsifier or breaker.
